(19) United States
(12) Patent Application Publication
(10) Pub. No.: US 2017/0033501 A1
(43) Pub. Date: Feb. 2, 2017

(54) BRACKET STRUCTURE OF ELECTRICAL CONNECTOR

(71) Applicant: KINNEXA, INC., Taipei City (TW)

(72) Inventor: SHIN-HAO CHIEN, Taipei City (TW)

(21) Appl. No.: 14/811,840

(22) Filed: Jul. 29, 2015

(51) Int. Cl. H01R 13/639; F16M 13/02

(52) U.S. Cl. CPC H01R 13/6395; F16M 13/02

(57) ABSTRACT

A bracket structure is provided for use with an electrical connector and includes at least one clamping section extending from one side of the bracket and at least one retention section formed on one side of the clamping section. The retention section includes two spaced bending portions and at least one engagement section formed between the two bending portions to allow the bracket to be coupled to and retained on the electrical connector. With such a structure, a user may use clamping section that is formed directly on or indirectly extending from the bracket, the retention section, the bending portions, and the engagement section to have the bracket coupled to and retained on the electrical connector. A process for manufacturing such a bracket is relatively simple. Further, combination with an electrical connector can be done by having the retention section coupled to the electrical connector.

### TECHNICAL FIELD OF THE INVENTION

The present invention relates generally to a bracket structure of an electrical connector, and more particularly to a bracket structure of an electrical connector that has a simple structure and a simple process of manufacturing, meets the standards of related associates, and allows for efficient and stable coupling and mounting to an electrical connector.

### DESCRIPTION OF THE PRIOR ART

The high development of modern electronic technology brings various sorts of electronic products to every corner of the modern society. Computers are the primary ones among these electronic products. A computer comprises a main board and various circuit substrates of different form of are mounted to the main board. Some of such circuit board comprise electrical connector exposed outside the computer for receiving a connection terminal of a peripheral device, such as a monitor, a mouse, a speaker, a network card, a memory card, and a portable disc drive, to insert into a corresponding connection port in order to expand the functionality of the computer. Such electrical connectors have a portion that is exposed outside the computer and is commonly fixed using a bracket (or a shield plate). A conventional way is to screw a locking tab formed on one end of the bracket to the computer, while an opposite end is directly inserted into the computer. Such a way of fixation is obviously weak.

To reinforce the strength of fixation, some manufacturers provide a bracket that has an extension having an end forming a barb, as shown in FIG. 1, which provides a schematic view illustrating the fixation achieved with the conventional connector bracket. The bracket, which is designated at 9, comprises a barbed section 91 that extends over a connection port 8 to be retained at an opposite side of connection terminal. Such a way of fixation is generally stable; however, there are still drawbacks, which needs further improvement, in the use thereof.

(1) The operation of coupling is inconvenient, for the connection port 8 must be carefully fit into the barbed section 91, otherwise the barbed section 91 may get deformed.

(2) Such a way of fixation by extending over the connection port 8 requires an increased overall thickness and coupling tolerance must be preserved between the barbed section 91 and the connection port 8, rendering the bracket 9 not satisfying the standards of the related associates.

Thus, it is a challenge of the present inventor and those involved in this business to develop a solution that overcomes the above problems and deficiencies.

### SUMMARY OF THE INVENTION

In view of the above drawbacks, through collection of data and assessment and consideration in multiple aspects, in combination with years' experience in the associated business, the present inventor creates, through repeated trivial and modification, a bracket structure of an electrical connector that has a simple structure and a simple process of manufacturing, meets the standards of related associates, and allows for an efficient and stable operation of coupling.

The primary object of the present invention is to provide an advantage of efficient assembly and firm stability through an engagement technique involving an engagement section and a coupling section.

To achieve the above object, the present invention provides a structure that comprises: at least one clamping section extending from one side of the bracket, the clamping section comprising at least one retention section formed on one side thereof, the retention section comprising two bending portions that are spaced from each other and at least one engagement section formed between the two bending portions to allow the bracket to be coupled to and retained on an electrical connector. When a user attempts to combine the electrical connector and the bracket, the electrical connector is first aligned with the retention section of the bracket and a force is applied to have the engagement section and a coupling section of the electrical connector engaging and bearing each other with the clamping section positioned against one side of the electrical connector. Due to the presence of the bending portions, the combination operation of the bracket is provided with a certain extent of elasticity so that the mating engagement between the two is made efficient and simple. Further, such a way of combination provides a relatively high degree of stability and meets the standards of the related associates for height.

With the above techniques, the problem that the conventional connector bracket requires an operation that involves a barbed section is more complicated and the entire height after assembly and fixation exceeds the standards of the related associates can be overcome and the above-descried advantages can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing fixation achieved with a conventional connector bracket.

FIG. 2 is a perspective view showing a preferred embodiment of the present invention.

FIG. 2A is an enlarged view of a circled portion of FIG. 2.

FIG. 3 is a perspective view showing an electrical connector according to the preferred embodiment of the present invention.

FIG. 3A is an enlarged view of a circled portion of FIG. 3.

FIG. 4 is a schematic view illustrating assembly of the preferred embodiment of the present invention.

FIG. 4A is an enlarged view of a circled portion of FIG. 4.

FIG. 5 is another schematic view illustrating the assembly of the preferred embodiment of the present invention.

FIG. 5A is an enlarged view of a circled portion of FIG. 5.

FIG. 6 is an exploded view illustrating another embodiment of the present invention.

FIG. 6A is an enlarged view of a circled portion of FIG. 6.

FIG. 7 is a schematic view illustrating assembly of said another embodiment of the present invention.

FIG. 8 is a perspective view illustrating a further embodiment of the present invention.

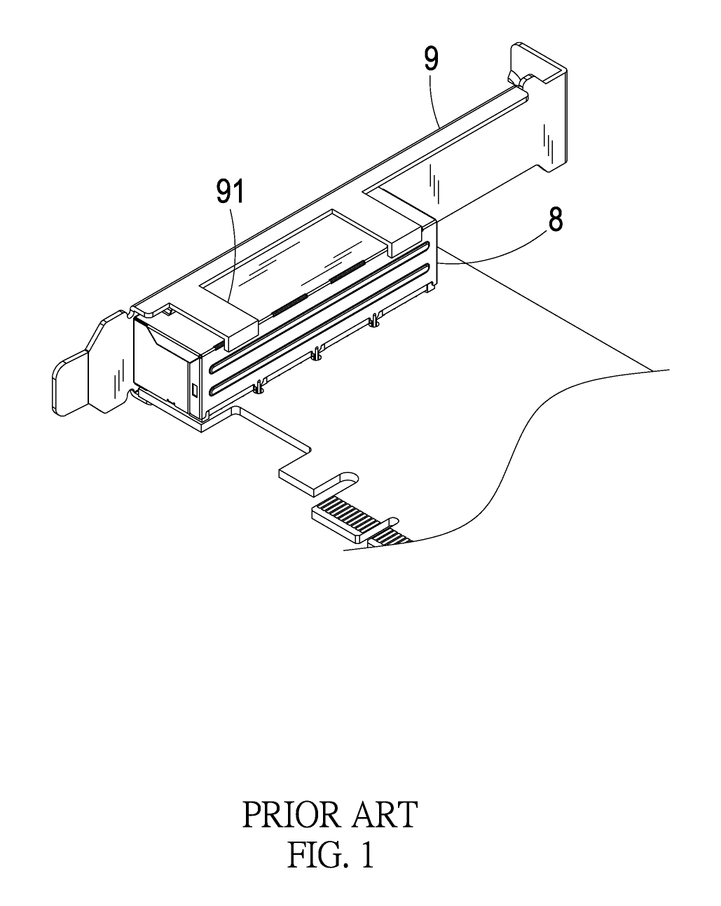

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

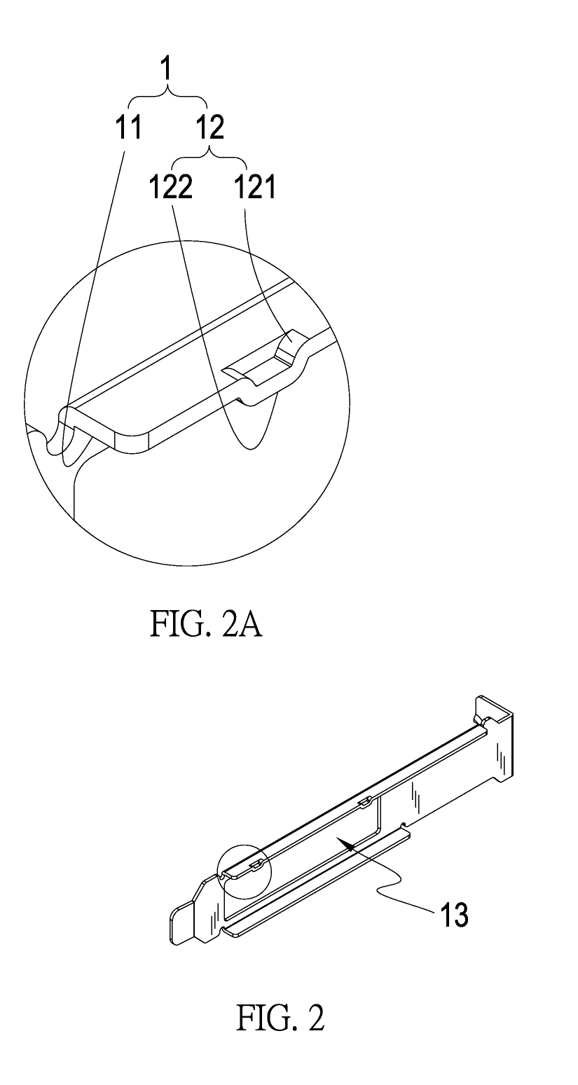

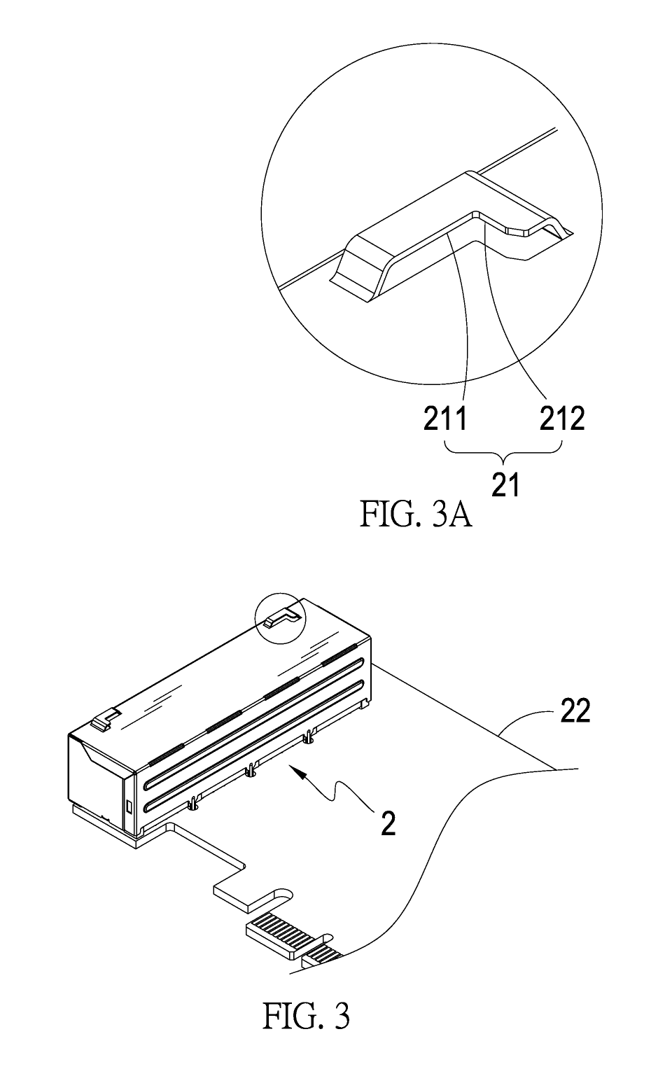

Referring FIGS. 2 and 3, which are respectively a perspective view showing a preferred embodiment of the present invention and a perspective view showing an electrical connector according to the present invention, these drawings clearly show that a bracket 1 according to the present invention comprises:

at least one clamping section 11 extending from one side of the bracket 1;

at least one retention section 12 formed on one side of the clamping section 11, the retention section 12 comprising two bending portions 121 that are arranged to be spaced from each other and at least one engagement section 122 formed between the two bending portions 121 for allowing the bracket 1 to be coupled to and retained on an electrical connector 2, wherein the electrical connector 2 is mounted on a circuit substrate 22;

at least one coupling section 21 formed on and raised from the electrical connector 2 for corresponding to and coupling with the engagement section 122, the coupling section 21 being of one of an L-shape and a U-shape, the coupling section 21 comprising a bearing section 211 formed on one side thereof for engaging and bearing the engagement section 12, the coupling section 21 further comprising a limiting section 212 formed on at least one side of the bearing section 211 for limiting the position of the bracket 1 in a lateral direction; and

the bracket 1 comprising an opening section 13 formed in one side thereof, the opening section 13 being located to correspond to an insertion terminal port of the electrical connector 2.

The structure of the technique of the present invention can be appreciated from the above description. Mating that is achieved with such a structure provides advantages of simple structure, simple manufacturing, meeting the standards of related associates, and being efficient and stable. Explanation in detail will be available from the following description.

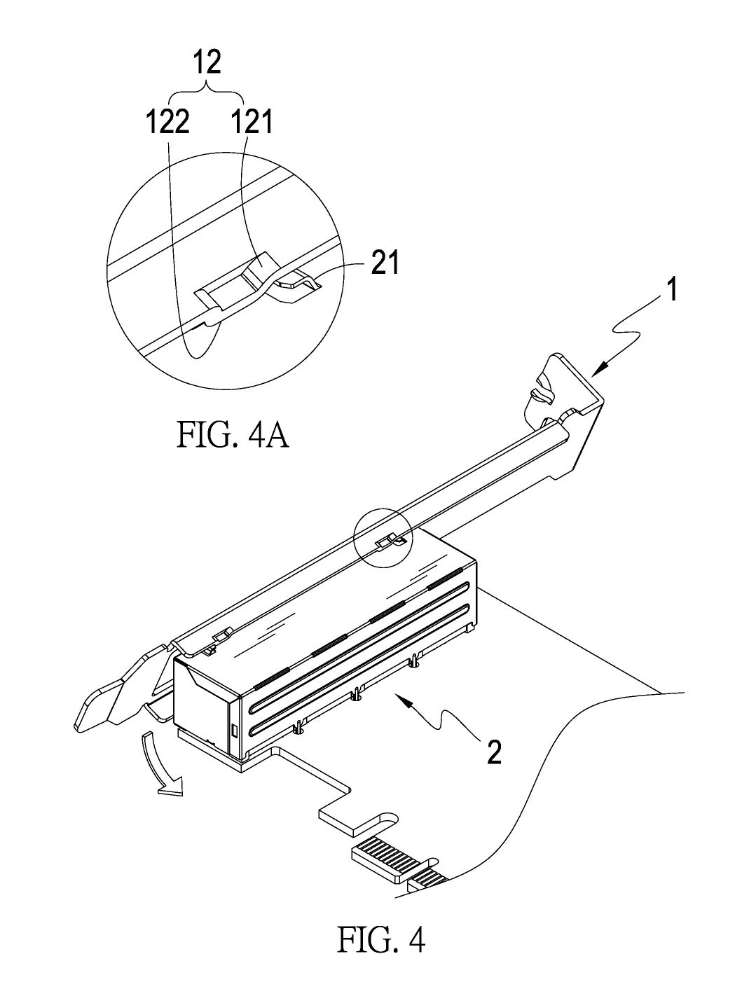

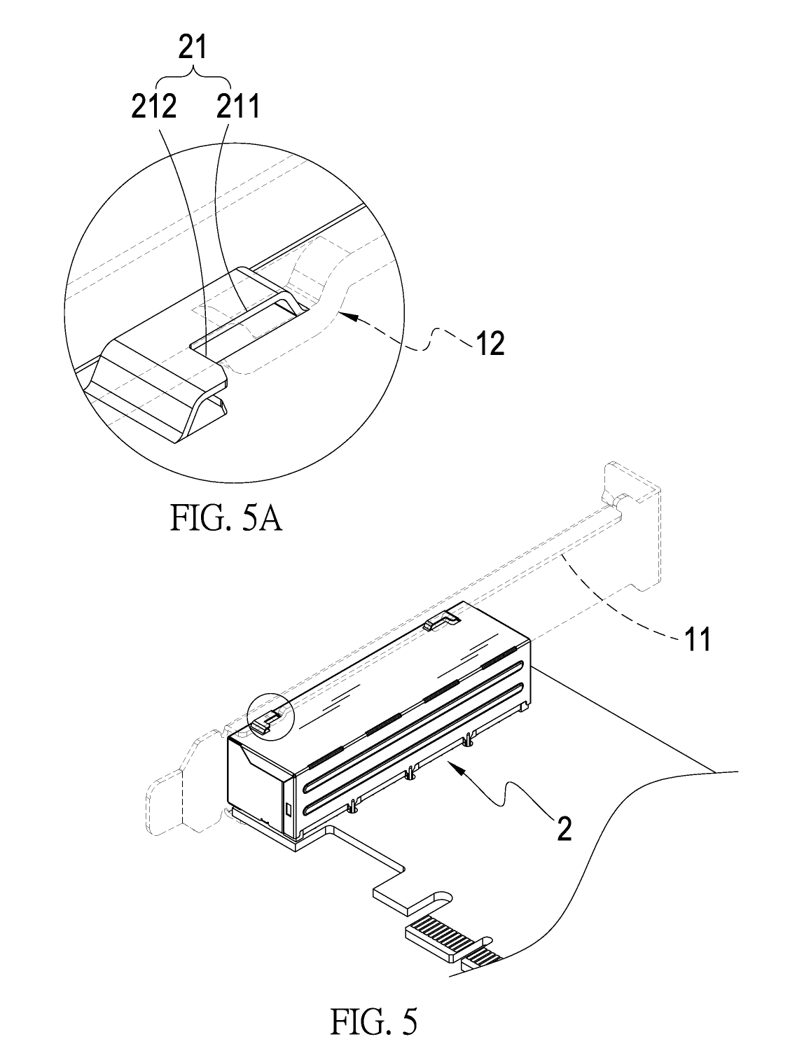

Referring collectively to FIGS. 2-5, which are respectively a perspective view showing a preferred embodiment of the present invention, a perspective view showing an electrical connector according to the present invention, a schematic view illustrating assembly of the present invention, and another schematic view illustrating the assembly of the present invention, these drawings clearly show that the clamping section 11 that is formed by extending one side of the bracket 1 is subjected to stamping to form at least one retention section 12 and the retention section 12 comprises two spaced bending portions 121 and an engagement section 122 that is naturally formed between the two bending portions 121 for being coupled to and retained on the coupling section 21 of the electrical connector 2. As to the coupling section 21 of the electrical connector 2, formation is similarly achieved with stamping applied to the electrical connector 2 (where in the instant embodiment, the coupling section 21 is of an L-shaped). Thus, the present invention provides an advantage of easy operation of a manufacturing process and a reduced manufacturing cost.

When a user attempts to combine the electrical connector 2 and the bracket 1 to each other, firstly, the retention section 12 is aligned with the coupling section 21 with the engagement section 122 and the bearing section 211 bearing and supporting each other and then a force is applied to press down the bracket 1 to have the clamping section 11 positioned flat on a surface of the coupling section 21 of the electrical connector 2, meanwhile the limiting section 212 limits the position of the retention section 12 in a lateral direction with the opening section 13 corresponding in position to the insertion terminal port of the electrical connector 2 to thereby accomplish the operation of combination and assembly. During the application of force, inherent elasticity of the bending portions 121 is used to allow for smooth combination and assembly between the bracket 1 and the electrical connector 2, while also helps achieve desired combination strength and stability.

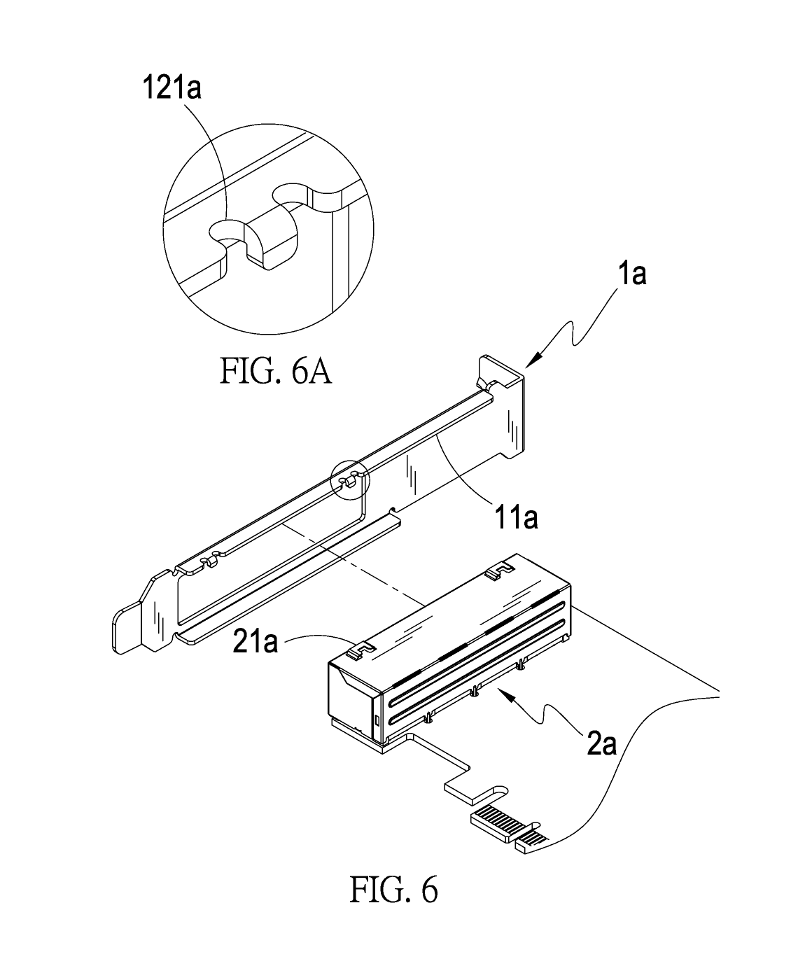

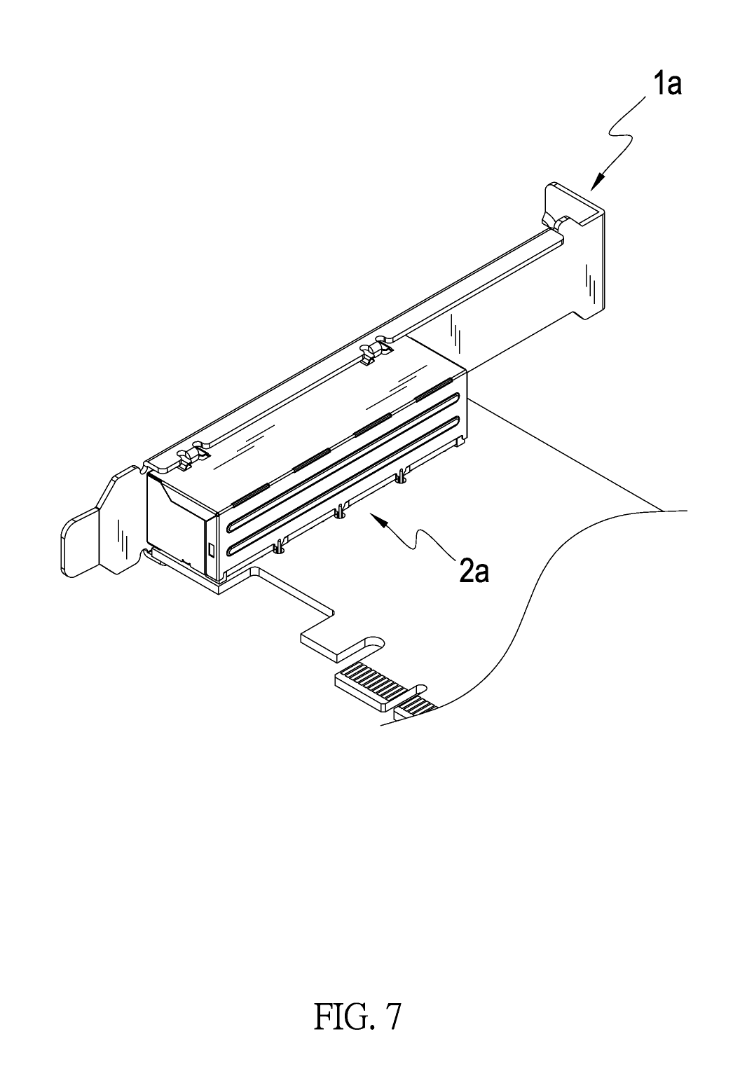

Further, referring collectively to FIGS. 6 and 7, which are respectively an exploded view illustrating another embodiment of the present invention and a schematic view illustrating assembly of the present invention, these drawings clearly show the instant embodiment is a different form of embodiment of the bending portions 121a. Two bending portions 121a that are bent inwardly are formed in the clamping section 11a and the bending portions 121a are arranged in such a way as to be located closely adjacent to an outer edge of coupling sections 21a. In the instant embodiment, the coupling sections 21a are of a U-shaped. Operation can be conducted is a way similar to that of the previous embodiment so that repeated description will be omitted. However, during the process of assembly, avoidance achieved with the bending portions 121a allows for an even smoother operation of assembly with the bracket la and also meeting the standards of the related associates for height of the electrical connector 2a.

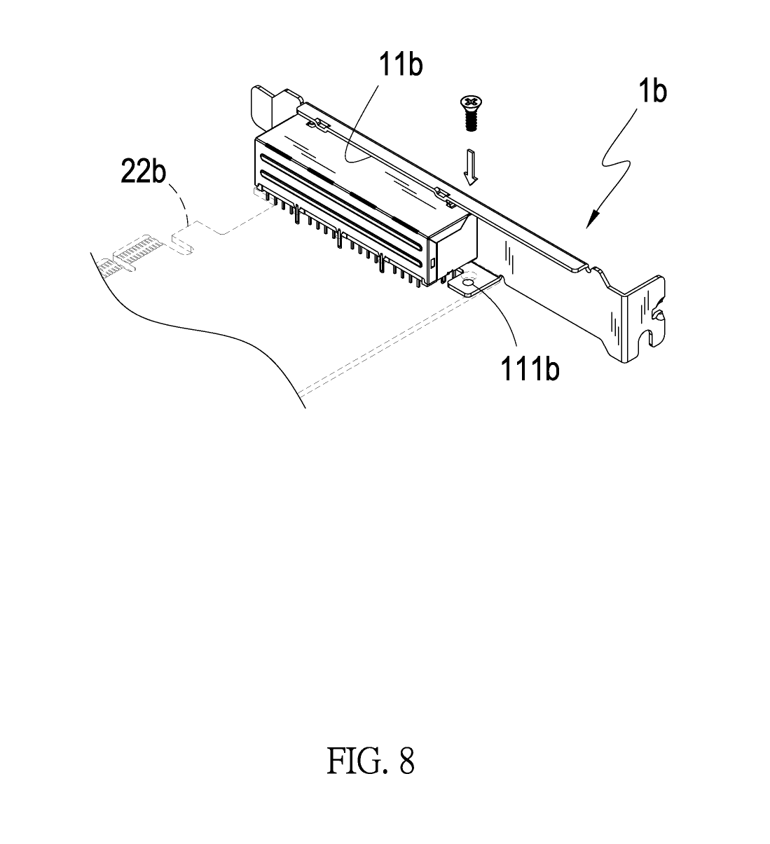

Referring to FIG. 8, which is a schematic view illustrating a further embodiment of the present invention, the drawing clearly shows the instant embodiment is quite similar to the previous embodiment except that at least one locking hole 111b is formed in the clamping section 11b for being fixed to the circuit substrate 22b to increase the strength of fixation of the bracket 1b.

However, what is described above is just some preferred embodiments of the present invention and is not intended to limit the scope of the present invention. Simple modifications and equivalent structure variations, which are made based on the teachings given in the disclosure and drawings of the present invention, are considered within the scope of the present invention.

Thus, referring to all the drawings, the present invention, when put into use, possesses the following advantages over the prior art:

(1) The structure is simple and the operation is also simple, and the manufacturing cost is low.

(2) The operation of assembly is efficient and stable and meets the standards of the associates for height.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A bracket structure of an electrical connector, wherein the bracket comprises:
at least one clamping section extending from one side of the bracket; and
at least one retention section formed on one side of the clamping section, the retention section comprises two bending portions that are arranged to space from each other, and at least one engagement section formed between the two bending portions for allowing the bracket to be coupled to and retained on an electrical connector.

2. The bracket structure of the electrical connector according to claim 1, wherein the electrical connector at least one coupling section formed on and raised therefrom for corresponding to and coupling with the engagement section.

3. The bracket structure of the electrical connector according to claim 2, wherein the clamping section is flat positionable on a surface of the coupling section.

4. The bracket structure of the electrical connector according to claim 2, wherein a bearing section is formed on one side of the coupling section for engaging and bearing the engagement section.

5. The bracket structure of the electrical connector according to claim 4, wherein the coupling section further comprises a limiting section formed on at least one side of the bearing section for limiting the position of the bracket in a lateral direction.

6. The bracket structure of the electrical connector according to claim 2, wherein the coupling section is of one of an L-shape and a U-shape.

7. The bracket structure of the electrical connector according to claim 1, wherein the electrical connector is mounted on a circuit substrate.

8. The bracket structure of the electrical connector according to claim 7, wherein the clamping section comprises at least one locking hole formed therein for fixing to the circuit substrate.

9. The bracket structure of the electrical connector according to claim 1, wherein the bracket comprises an opening section formed in one side thereof, the opening section corresponding in position to an insertion terminal port of the electrical connector.

10. The bracket structure of the electrical connector according to claim 1, wherein the electrical connector is a network connector.
